(19) United States
(12) Patent Application Publication
(10) Pub. No.: US 2017/0284652 A1
(43) Pub. Date: Oct. 5, 2017

(54) HEAT RADIATION MEMBER AND LIGHTING DEVICE

(71) Applicant: MINEBEA MITSUMI INC., Nagano (JP)

(72) Inventor: Masahiro KITAGAWA, Kakegawa (JP)

(73) Assignee: MINEBEA MITSUMI INC., Nagano (JP)

(21) Appl. No.: 15/472,807

(22) Filed: Mar. 29, 2017

(30) Foreign Application Priority Data
Apr. 1, 2016 (JP) 2016-074742

(51) Int. Cl. F21V 29/83; F21V 29/76; F28F 3/04

(52) U.S. Cl. CPC F21V 29/83; F28F 3/048; F21V 29/763; F28F 2215/10

(57) ABSTRACT

A heat radiation member according to an embodiment includes a plurality of heat radiation fins each formed in a plate shape and a plurality of ribs. The plurality of heat radiation fins is disposed upright from a base on which a light source is to be fitted, and is arranged in a predetermined direction. The plurality of ribs extends to each of facing surfaces of the plurality of heat radiation fins and is provided on a part of the plurality of heat radiation fins in an upright direction.

### CROSS-REFERENCE TO RELATED APPLICATION(S)

The present application claims priority to and incorporates by reference the entire contents of Japanese Patent Application No. 2016-074742 filed in Japan on Apr. 1, 2016.

### BACKGROUND OF THE INVENTION

### 1. Field of the Invention

The present invention relates to a heat radiation member and a lighting device.

### 2. Description of the Related Art

Conventionally, lighting devices that can change the irradiation direction in any desired direction such as a spotlight have been provided. A lighting device such as the above include a heat radiation member for effectively radiating heat produced by, for example, a light source. For example, the heat radiation member of the lighting device is a heat radiation member including a plurality of heat radiation fins each formed in a plate shape. For example, in the heat radiation member such as the above, the heat radiation fins are arranged in a predetermined direction.

In a conventional lighting device (for example, see FIG. 10), a rib for linking the heat radiation fins is provided in the heat radiation member in which the heat radiation fins are arranged in one direction, to reinforce the heat radiation fins. For example, in the lighting device such as the above, a rib is formed across the entire heat radiation fins in the upright direction, so as to link the center portions of the heat radiation fins in the width direction (Japanese Patent Application Laid-open No. 2014-049347).

Consequently, for example, in the conventional lighting device, when the orientation of the lighting device is in the horizontal direction, the rib is positioned in the horizontal direction. Thus, it is difficult to prevent heat radiation efficiency from reducing. In this manner, with the conventional technology described above, for example, it is difficult to make the heat radiation by the heat radiation member less affected by the change in the irradiation direction, in the lighting device that can change the irradiation direction in a desirable direction.

### SUMMARY OF THE INVENTION

It is an object of the present invention to at least partially solve the problems in the conventional technology.

A heat radiation member according to an embodiment includes a plurality of heat radiation fins each formed in a plate shape and a plurality of ribs. The plurality of heat radiation fins is disposed upright from a base on which a light source is to be fitted, and is arranged in a predetermined direction. The plurality of ribs extends to each of facing surfaces of the plurality of heat radiation fins and is provided on a part of the plurality of heat radiation fins in an upright direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a lighting device according to an embodiment;

FIG. 2 is a perspective view illustrating the lighting device according to the embodiment;

FIG. 3 a perspective view illustrating the lighting device according to the embodiment;

FIG. 4 is a plan view illustrating the lighting device according to the embodiment;

FIG. 5 is a side view illustrating the lighting device according to the embodiment;

FIG. 6 is a diagram illustrating relations between the orientation of the lighting device and first ribs according to the embodiment;

FIG. 7 is a diagram illustrating relations between the orientation of the lighting device and second ribs according to the embodiment;

FIG. 8 is a diagram illustrating a comparison between the embodiment and a conventional example;

FIG. 9 is a perspective view illustrating another lighting device that uses a heat radiation member according to the embodiment;

FIG. 10 is a perspective view illustrating a lighting device according to the conventional example;

FIG. 11 is a perspective view illustrating the lighting device according to the conventional example;

FIG. 12 is a plan view illustrating the lighting device according to the conventional example;

FIG. 13 is a side view illustrating the lighting device according to the conventional example; and

FIG. 14 is a diagram illustrating relations between the orientation of the lighting device and a center rib according to the conventional example.

### DETAILED DESCRIPTION OF THE PREFERRED EMBODIMENTS

Hereinafter, a lighting device that includes a heat radiation member according to an embodiment will be described with reference to the accompanying drawings. It is to be understood that the usage of a heat radiation member 30 is not limited to the embodiment to be described below. Further, it should be noted that the drawings are schematic, and the dimensional relations between the components, the ratios between the components, and the like may differ from the actual ones. It should also be noted that the respective drawings may include portions that have different dimensional relations or ratios.

### Embodiment

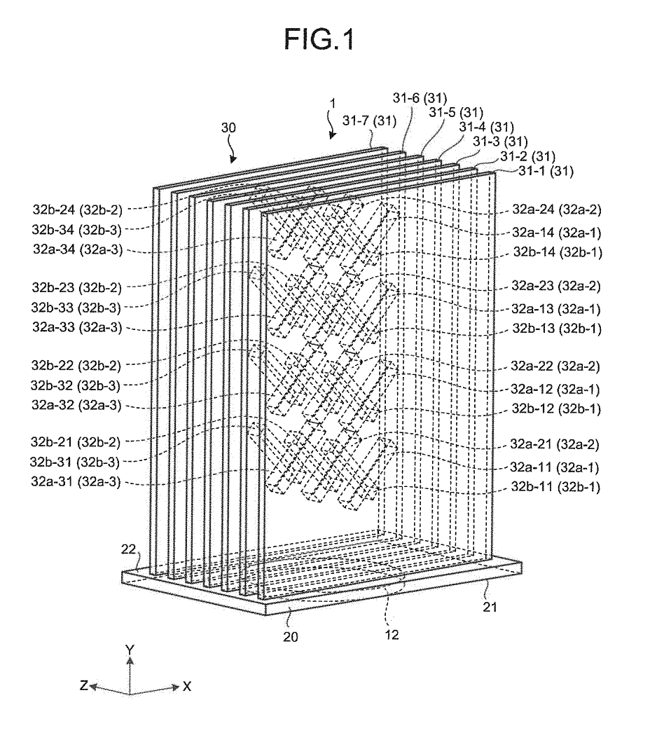

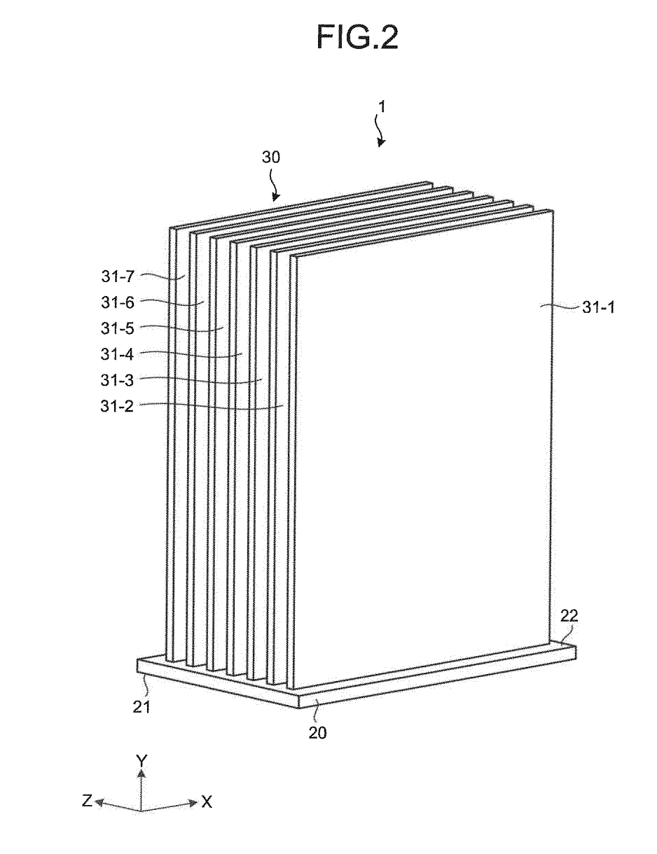

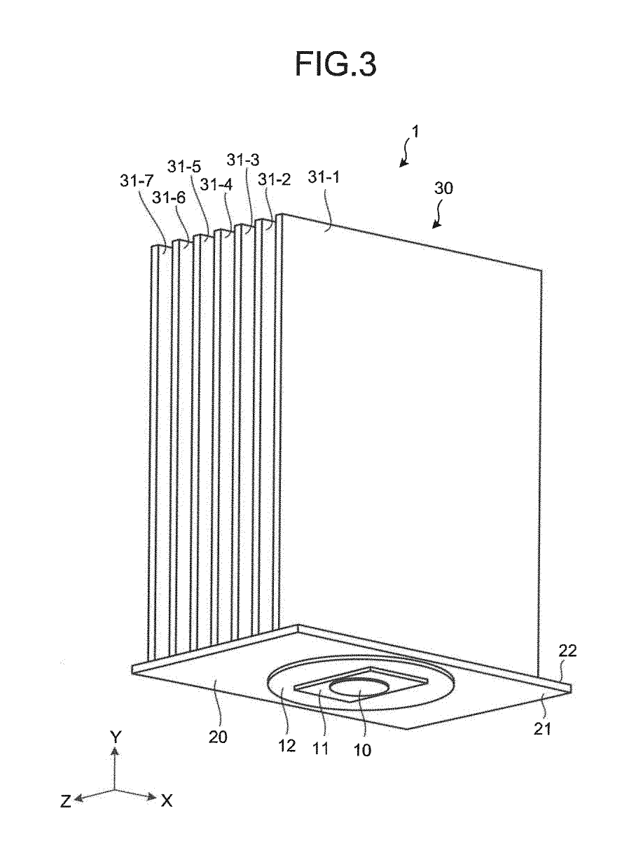

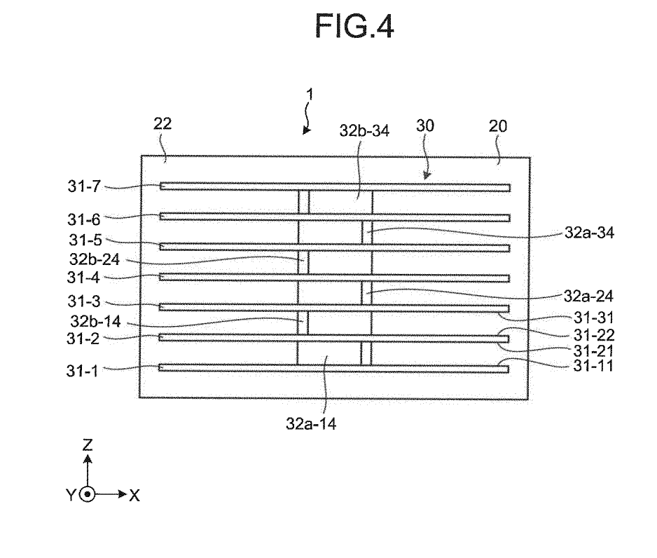

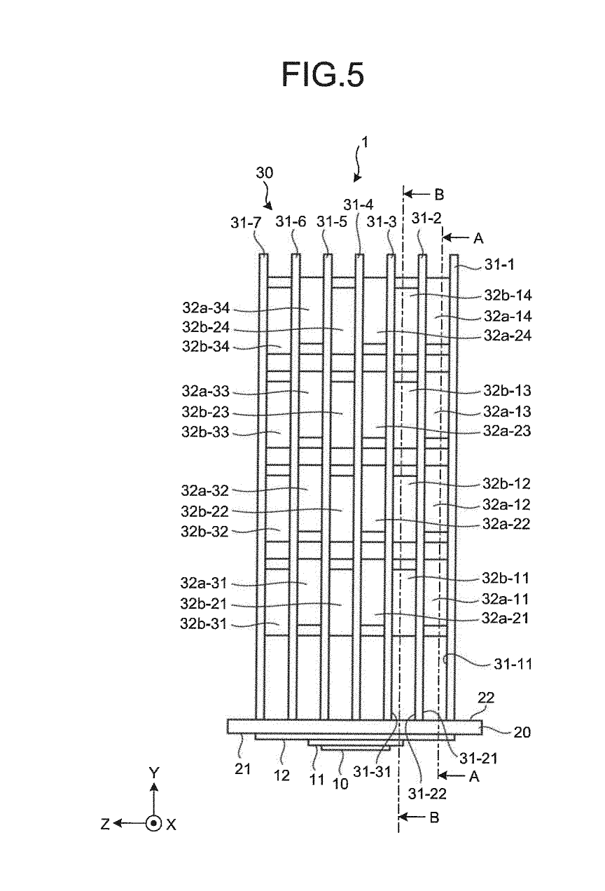

First, an outline of a structure of a lighting device 1 will be described with reference to FIG. 1 to FIG. 5. FIG. 1 is a perspective view illustrating a lighting device according to the embodiment. More specifically, FIG. 1 is a perspective view of the lighting device 1 excluding a light source 10 and a substrate 11. FIG. 2 and FIG. 3 are perspective views each illustrating the lighting device according to the embodiment. More specifically, FIG. 2 is a perspective view illustrating the structure of the lighting device 1 on a side where the heat radiation member 30 is disposed upright. FIG. 3 is a perspective view illustrating the structure of the lighting device 1 on a side where the light source 10 is arranged. FIG. 4 is a plan view illustrating the lighting device according to the embodiment. FIG. 5 is a side view illustrating the lighting device according to the embodiment. In the following, the horizontal direction of heat radiation fins 31 illustrated in FIG. 4 is the width direction, and the vertical direction of the heat radiation fins 31 is the thickness direction. Further, the vertical direction of the heat radiation fins 31 in FIG. 5 is the upright direction (height direction). In other words, in the examples illustrated in FIG. 1 to FIG. 5, the X axis direction is the width direction of the heat radiation fins 31, the Y axis direction is the upright direction of the heat radiation fins 31, and the Z axis direction is the thickness direction of the heat radiation fins 31.

The lighting device 1 includes the light source 10, a base 20 in a plate shape, and the heat radiation member 30. For example, the light source 10 is a predetermined light source such as a light emitting diode (LED). The light source 10 is provided on the substrate 11 in a rectangular plate shape, and the substrate 11 is arranged on a mounting unit 12 in a circular plate shape that is provided at the center of a one surface 21 of the base 20. Depending on the type of the light source 10, the lighting device 1 may not include the substrate 11, and the light source 10 may be directly mounted on the mounting unit 12.

For example, the base 20 is formed in a rectangular plate shape. Further, in the lighting device 1, the base 20 and the heat radiation member 30 may be formed integrally. In this case, the base 20 is formed of the same material as that of the heat radiation fins 31, and for example, is formed of a high heat conductivity material such as aluminum and copper. The base 20 may be made of any material as long as the material has a desirable heat conductivity. The size of the base 20 may be suitably set according to the light source 10 and the like to be fitted. For example, the length of the base 20 in the long-side direction (X axis direction) may be 100 mm, and the length of the base 20 in the short-side direction (I axis direction) may be 50 mm.

The heat radiation member 30 includes a plurality (seven pieces) of heat radiation fins 31-1 to 31-7 that is arranged in a predetermined direction. If the heat radiation fins 31-1 to 31-7 need not be distinguished from one another, they are referred to as the heat radiation fins 31. For example, the heat radiation fins 31 are formed of a high heat conductivity material such as aluminum and copper. The heat radiation fins 31 may be made of any material as long as the material has a desired heat conductivity.

The heat radiation fins 31 are disposed upright from an opposite surface 22 of the one surface 21 of the base 20. For example, the heat radiation fins 31 are disposed upright from the opposite surface 22 of the base 20, along the thickness direction (Z axis direction) of the heat radiation fins 31.

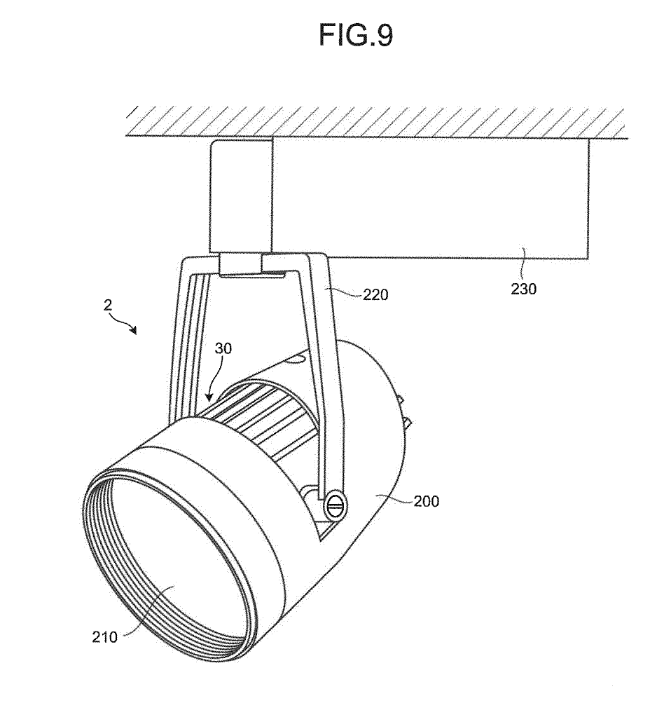

The thickness of the heat radiation fins 31 may be suitably set according to the height (length in the upright direction), the width (length the width direction), and the like. For example, the thickness of each of the heat radiation fins 31 may be 2 mm. Further, the height of the heat radiation fins 31 may be suitably set, and for example, may be 130 mm. The heat radiation fins 31 are arranged spaced apart between the heat radiation fins 31 by the distance that is suitably set according to the size of the heat radiation fins 31 and the like. For example, the heat radiation fins 31 are arranged spaced apart between the heat radiation fins 31 by 6 mm. In other words, the heat radiation fins 31 are arranged along the thickness direction of the heat radiation fins 31 at an interval of 6.2 mm. Further, it is assumed that the lighting device 1 rotates around an axis that passes through the center of the heat radiation fins 31 in the width direction (X axis direction), and that extends in the thickness direction (Z axis direction) of the heat radiation fins 31. For example, the base 20 of the lighting device 1 is fitted on a ceiling and a wall surface using a fitting mechanism 230 that includes a predetermined rotation mechanism such as an arm member 220 as illustrated in FIG. 9.

The heat radiation member 30 includes a plurality of ribs 32a-11 to 32a-34 as well as 32b-11 to 32b-34 that extends to and connects to each of facing surfaces of the heat radiation fins 31, and that are provided on a part of the heat radiation fins 31 in the upright direction (Y axis direction). Although the details will be described below, the ribs 32a-11 to 32a-34 and 32b-11 to 32b-34 are divided into first ribs 32a-11 to 32a-34 and second ribs 32b-11 to 32b-34, according to the inclination direction relative to the upright direction (Y axis direction) of the heat radiation fins 31. In the following, if the first ribs 32a-11 to 32a-34 need not be distinguished from one another, they are referred to as first ribs 32a. If the second ribs 32b-11 to 32b-34 need not be distinguished from one another, they are referred to as second ribs 32b. Further, if the first ribs 32a and the second ribs 32b need not be distinguished from one another, they may be simply referred to as ribs 32. For example, each of the ribs 32 is formed in a square column shape (rectangular rod shape). The size of the ribs 32 may be suitably set according to the size of the heat radiation fins 31, the interval between the heat radiation fins 31, and the like. For example, the length of the ribs 32 may be 28 mm.

The first ribs 32a and the second ribs 32b will now be described. First, the first ribs 32a will be described, based on the first ribs 32a that are provided between the heat radiation fin 31-1 and the heat radiation fin 31-2.

For example, as illustrated in FIG. 1 and FIG. 5, four of the first ribs 32a-11 to 32a-14 are provided between the heat radiation fin 31-1 and the heat radiation fin 31-2. If the first ribs 32a-11 to 32a-14 need not be distinguished from one another, they are referred to as first ribs 32a-1. For example, the heat radiation member 30 includes four of the first ribs 32a-1 between a facing surface 31-11 that faces the heat radiation fin 31-2 in the heat radiation fin 31-1, and a facing surface 31-21 that faces the heat radiation fin 31-1 in the heat radiation fin 31-2. In the example illustrated in FIG. 1, the first ribs 32a-11 to 32a-14 are sequentially provided in this order from the side of the opposite surface 22 of the base 20, between the facing surface 31-11 of the heat radiation fin 31-1 and the facing surface 31-21 of the heat radiation fin 31-2.

In this example, the first ribs 32a-1 are inclined relative to the upright direction of the heat radiation fins 31. In FIG. 4, the first ribs 32a-1 are inclined so as to widen the distance from the opposite surface 22 of the base 20, toward the end that is positioned at the right side from the end that is positioned at the left side. In FIG. 4, the position of the center of the first ribs 32a-1. in the horizontal direction and the position of the center of the heat radiation fins 31 in the width direction are overlapped with each other, in the width direction of the heat radiation fins 31. The direction toward which the first ribs 32a are inclined may be referred to as a first direction. In this manner, the inclination directions of the ribs 32 (first ribs 32a) between the pair of the facing surfaces 31-11 and 31-21 are aligned relative to the upright direction of the heat radiation fins 31.

Further, four of the first ribs 32a-21 to 32a-24 are provided between the heat radiation fin 31-3 and the heat radiation fin 31-4. If the first ribs 32a-21 to 32a-24 need not be distinguished from one another, they are referred to as first ribs 32a-2. For example, the heat radiation member 30 includes four of the first ribs 32a-2 between a facing surface that faces the heat radiation fin 31-4 in the heat radiation fin 31-3, and a facing surface that faces the heat radiation fin 31-3 in the heat radiation fin 31-4. Further, the first ribs 32a-2 are inclined in the first direction relative to the upright direction of the heat radiation fins 31.

Further, four of the first ribs 32a-31 to 32a-34 are provided between the heat radiation fin 31-5 and the heat radiation fin 31-6. If the first ribs 32a-31 to 32a-34 need not be distinguished from one another, they are referred to as first ribs 32a-3. For example, the heat radiation member 30 includes four of the first ribs 32a-3 between a facing surface that faces the heat radiation fin 31-6 in the heat radiation fin 31-5, and a facing surface that faces the heat radiation fin 31-5 in the heat radiation fin 31-6. Further, the first ribs 32a-3 are inclined in the first direction relative to the upright direction of the heat radiation fins 31.

In this manner, the first ribs 32a are provided spaced apart in the upright direction of the heat radiation fins 31. For example, as illustrated in FIG. 5, a predetermined interval is provided between the first rib 32a-11 and the first rib 32a-12 in the upright direction of the heat radiation fins 31. Further, a predetermined interval is provided between the first rib 32a-12 and the first rib 32a 13 in the upright direction of the heat radiation fins 31. Furthermore, a predetermined interval is provided between the first rib 32a-13 and the first rib 32a-14 in the upright direction of the heat radiation fins 31. In this manner, for example, the heat radiation member 30 can be easily manufactured, by providing a predetermined interval between the first ribs 32a that are provided between the facing surfaces of the heat radiation fins 31, in the upright direction of the heat radiation fins 31.

Next, the second ribs 32b will be described based on the second ribs 32b that are provided between the heat radiation fin 31-2 and the heat radiation fin 31-3.

For example, as illustrated in FIG. 1 and FIG. 5, four of the second ribs 32b-11 to 32b-14 are provided between the heat radiation fin 31-2 and the heat radiation fin 31-3. If the second ribs 32b-11 to 32b-14 need not be distinguished from one another, they are referred to as second ribs 32b-1. For example, the heat radiation member 30 includes four of the second ribs 32b-1 between a facing surface 31-22 that faces the heat radiation fin 31-3 in the heat radiation fin 31-2, and a facing surface 31-31 that faces the heat radiation fin 31-2 in the heat radiation fin 31-3. In the example illustrated in FIG. 1, the second ribs 32b-11 to 32b-14 are sequentially provided in this order between the facing surface 31-22 of the heat radiation fin 31-2 and the facing surface 31-31 of the heat radiation fin 31-3, from the side of the opposite surface 22 of the base 20.

In this example, the second ribs 32b-1 are inclined relative to the upright direction of the heat radiation fins 31. In FIG. 4, the second ribs 32b-1 are inclined so as to widen the distance from the opposite surface 22 of the base 20, toward the end that is positioned on the left side from the end that is positioned on the right side. In FIG. 4, the position of the center of the second ribs 32b-1 in the horizontal direction and the position of the center of the heat radiation fins 31 in the width direction are overlapped with each other, in the width direction of the heat radiation fins 31. The direction toward which the second ribs 32b are inclined may be referred to as a second direction. In this manner, the inclination directions of the ribs 32 (second ribs 32b) between the pair of the facing surfaces 3122 and 31-31 are aligned relative to the upright direction of the heat radiation fins 31.

Four of the second ribs 32b-21 to 32b-24 are provided between the heat radiation fin 31-4 and the heat radiation fin 31-5. If the second ribs 32b-21 to 32b-24 need not be distinguished from one another, they are referred to as second ribs 32b-2. For example, the heat radiation member 30 includes four of the second ribs 32b-2 between a facing surface that faces the heat radiation fin 31-5 in the heat radiation fin 31-4, and a facing surface that faces the heat radiation fin 31-4 in the heat radiation fin 31-5. Further, the second ribs 32b-2 are inclined in the second direction relative to the upright direction of the heat radiation fins 31.

Furthermore, four of the second ribs 32b-31 to 32b-34 are provided between the heat radiation fin 31-6 and the heat radiation fin 31-7. If the second ribs 32b-31 to 32b-34 need not be distinguished from one another, they are referred to as second ribs 32b-3. For example, the heat radiation member 30 includes four of the second ribs 32b-3 between a facing surface that faces the heat radiation fin 31-7 in the heat radiation fin 31-6, and a facing surface that faces the heat radiation fin 31-6 in the heat radiation fin 31-7. Further, the second ribs 32b-3 are inclined in the second direction relative to the upright direction of the heat radiation fins 31.

In this manner, the second ribs 32b are provided spaced apart in the upright direction of the heat radiation fins 31. For example, as illustrated in FIG. 5, a pr determined interval is provided between the second rib 32b-11 and the second rib 32b-12 in the upright direction of the heat radiation fins 31. Further, a predetermined interval is provided between the second rib 32b-12 and the second rib 32b-13 in the upright direction of the heat radiation fins 31. Furthermore, a predetermined interval is provided between the second rib 32b-13 and the second rib 32b-14 in the upright direction of the heat radiation fins 31. In this manner, for example, the heat radiation member 30 can be easily manufactured, by providing a predetermined interval between the second ribs 32b that are provided between the facing surfaces of the heat radiation fins 31 in the upright direction of the heat radiation fins 31.

Further, as illustrated in FIG. 1, the second direction is inclined in the opposite direction to the first direction. In other words, the ribs 32 that are provided on each of the facing surfaces of the heat radiation fins 31 include a group of first ribs 32a that is inclined in the first direction relative to the upright direction of the heat radiation fins 31, and a group of second ribs 32b that is inclined in the second direction being opposite to the first direction, relative to the upright direction of the heat radiation fins 31.

For example, in the plan view of the heat radiation fin 31, when the first direction is inclined by a predetermined angle in one direction (hereinafter, also referred to as an “inclined angle”), relative to a virtual line that passes through the center of the heat radiation fin 31 in the width direction and that extends in the upright direction, the second direction is inclined by the predetermined angle (inclined angle) in the other direction, relative to the virtual line. More specifically, in the plan view of the heat radiation fin 31, when the first direction is inclined by 45 degrees toward the right relative to the virtual line that passes through the center of the Heat radiation fin 31 in the width direction and that extends in the upright direction, the second direction is inclined by 45 degrees toward the left, relative to the virtual line. The inclined angle is not limited to 45 degrees, and for example, may be set to various angles such as 30 degrees. For example, the inclined angle may be suitably set within a range larger than 0 degree and less than 90 degrees.

In the example illustrated above, the heat radiation fins 31 are odd in number. The heat radiation member 30 includes seven pieces of the heat radiation fins 31-1 to 31-7. In this manner, there are six combinations of the facing surfaces of the heat radiation fins 31. Consequently, three groups of the first ribs 32a-1, 32a-2, and 32a-3, and three groups of the second 32b-1, 32b-2, and 32b-3 are provided between the heat radiation fins 31-1 to 31-7. For example, as each of the first ribs 32a-1, 32a-2, and 32a-3 includes four of the ribs 32, there are 12 pieces of the first ribs 32a. Further, for example, as each of the second ribs 32b-1, 32b-2, and 32b-3 includes four of the ribs 32, there are 12 pieces of the second ribs 32b. In other words, because the radiation fins 31 are odd in number, the group of first ribs 32a and the group of second ribs 32b are equal in number.

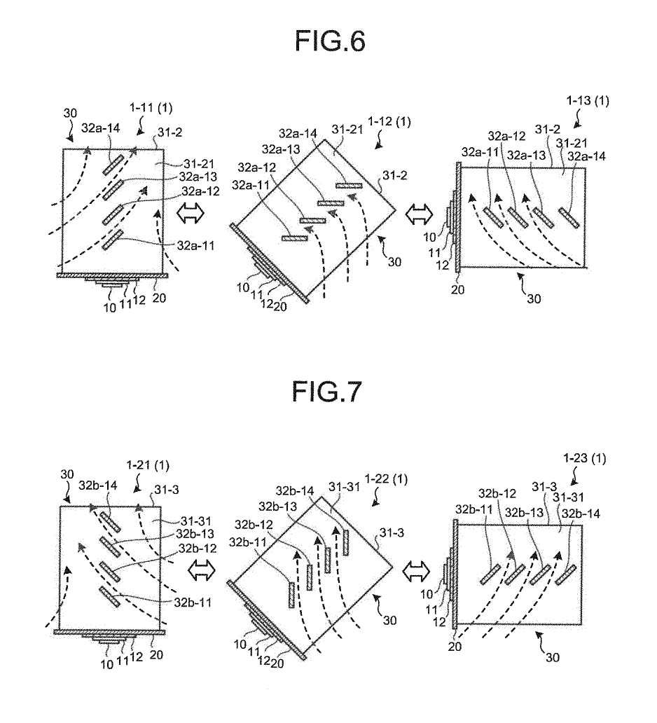

In this manner, it is possible to prevent heat radiation effect from reducing, without depending on the inclination direction of the lighting device 1 (toward which direction the lighting device 1 is oriented in the horizontal direction). This will now be described with reference to FIG. 6 and FIG. 7 FIG. 6 is a diagram illustrating relations between the orientation of the lighting device and the first ribs according to the embodiment. FIG. 7 is a diagram illustrating relations between the orientation of the lighting device and the second ribs according to the embodiment. A heat radiation state when the orientation of the lighting device 1 is changed will be described with reference to FIG. 6 and FIG. 7.

FIG. 6 is a diagram illustrating relations between the orientation of the lighting device 1 and the first ribs 34a. Each of lighting devices 1-11 to 1-13 illustrated in FIG. 6 is the lighting device 1 in each irradiation direction. If the lighting devices 1-11 to 1-13 need not be distinguished from one another, they are referred to as the lighting devices 1. Each of the lighting devices 1 illustrated in FIG. 6 is a plan view of a section taken along the line A-A in FIG. 5. More specifically, each of the lighting devices 1 illustrated in FIG. 6 is a plan view of the facing surface 31-21 that faces the heat radiation fin 31-1, in the heat radiation fin 31-2.

For example, the irradiation direction of the lighting device 1-11 is downward (directly downward). In the following, the direction toward which the one surface 21 of the base 20 in the lighting device 1-11 in FIG. 6 faces is the downward direction, and the direction toward which the opposite surface 22 of the base 20 in the lighting device 1-11 faces is the upward direction. The irradiation direction of the lighting device 1-12 is a direction inclined by 45 degrees (oblique direction) from the downward direction. The irradiation direction of the lighting device 1-13 is the lateral direction (horizontal direction), more specifically, in the leftward direction. The lighting device 1 can be rotated freely among the positions of the lighting device 1-11 to the lighting device 1-13.

The dotted lines that overlap with the heat radiation member 30 of the lighting device 1 illustrated in FIG. indicate the air flow in the heat radiation member 30. The dotted lines illustrated in FIG. 6 indicate the state of the flow of air that is warmed by the heat in the heat radiation member 30 in a virtual manner.

For example, in the lighting device 1-11, the heat transmitted from the light source 10 to the base 20 moves upward in the direction away from the base 20, that is, in the upright direction of the heat radiation member 30. For example, in the lighting device 1-11, the air being warmed by the heat that is transmitted from the light source 10 to the base 20 moves upward in the direction away from the base 20 along the inclination of the first ribs 32a, that is, in the upright direction of the heat radiation member 30. For example, in the lighting device 1-13, the heat transmitted from the light source 10 to the base 20 moves in the upward direction. For example, in the lighting device 1-13, the air warmed by the heat that is transmitted from the light source 10 to the base 20 moves in the direction away from the base 20 along the inclination of the first ribs 32a, that is, in the upward direction.

Further, for example, at the portion above the first ribs 32a of the lighting device 1-12, the air being warmed by the heat that is transmitted from the light source 10 to the base 20 moves in the direction away from the base 20, that is, in the upward direction. Furthermore, for example, at the portion below the first ribs 32a of the lighting device 1-12, the first ribs 32a are positioned above so that the width direction of the first ribs 32a is in the horizontal direction. Thus, the first ribs 32a affect the air being warmed by the heat that is transmitted from the light source 10 to the base 20. However, because there are intervals between the first ribs 32a, the air passes through the first ribs 32 and moves in the direction away from the base 20, that is, in the upward direction. In other words, because the first ribs 32a-1 to 32a-3 between the facing surfaces are provided on a part of the heat radiation fins 31 in the upright direction, instead of being provided across the entire heat radiation fins 31 in the upright direction, the air passes through the first ribs 32a and moves in the direction away from the base 20, that is, in the upright direction, even if the width direction of the first ribs 32a is positioned in the horizontal direction, that is, even if the first ribs 32a are positioned so as to intersect with the upward direction of the air warmed by the heat. In this manner, in the lighting device 1-12, even if the heat radiation efficiency is reduced than those of the lighting devices 1-11 and 1-13 that correspond to the other irradiating directions, the air warmed by the heat is easily released upward than when a center rib 132 is formed across the entire heat radiation fins 131 in the upright direction, as a lighting device 100-3 in the conventional example. Consequently, it is possible to suppress the influence on heat radiation due to the change in orientation.

FIG. 7 is a diagram illustrating relations between the orientation of the lighting device 1 and the second ribs 32b. Each of lighting devices 1-21 to 1-23 illustrated in FIG. 7 is the lighting device 1 in each irradiation direction. If the lighting devices 1-21 to 1-23 need not he distinguished from one another, they are referred to as the lighting devices 1. Each of the lighting devices 1 illustrated in FIG. 7 is a plan view of a section taken along the line B-B in FIG. 5. More specifically, each of the lighting devices 1 illustrated in FIG. 7 is a plan view of the facing surface 31-31 that faces the heat radiation fin 31-2, in the heat radiation fin 31-3. The irradiation direction of the lighting device 1-21 corresponds to the irradiation direction of the lighting device 1-11 in FIG. 6. Further, the irradiation direction of the lighting device 1-22 corresponds to the irradiation direction of the lighting device 1-12 in FIG. 6, and the irradiation direction of the lighting device 1-23 corresponds to the irradiation direction of the lighting device 1-13 in FIG. 6.

For example, the irradiation direction of the lighting device 1-21 is downward (directly downward). In the following, the direction toward which the one surface 21 of the base 20 in the lighting device 1-21 in FIG. 7 faces is the downward direction, and the direction toward which the opposite surface 22 of the base 20 in the lighting device 1-21 faces is the upward direction. The irradiation direction of the lighting device 1-22 is a direction inclined by 45 degrees (oblique direction) from the downward direction. The irradiation direction of the lighting device 1-23 is the lateral direction (horizontal direction), more specifically, in the leftward direction.

The dotted lines that overlap with the heat radiation member 30 of the lighting device 1 illustrated in FIG. 7 indicate the air flow in the heat radiation member 30. The dotted lines illustrated in FIG. 7 indicate the state of the flow of air that is warmed by the heat in the heat radiation member 30 in a virtual manner.

For example, in the lighting device 1-21, the heat transmitted from the light source 10 to the base 20 moves upward in the direction away from the base 20, that is, in the upright direction of the heat radiation member 30. For example, in the lighting device 1-21, the air being warmed by the heat that is transmitted from the light source 10 to the base 20 moves upward in the direction away from the base 20 along the inclination of the second ribs 32b, that is, in the upright direction of the heat radiation member 30. For example, in the lighting device 1-23, the heat transmitted from the light source 10 to the base 20 moves in the upward direction. For example, in the lighting device 1-23, the air being warmed by the heat that is transmitted from the light source 10 to the base 20 moves in the direction away from the base 20 along the inclination of the second ribs 32b, that is, in the upward direction.

Further, for example, at the portion above the second ribs 32b of the lighting device 1-22, the air being warmed by the heat that is transmitted from the light source 10 to the base 20 moves in the direction away from the base 20, that is, in the upward direction. Furthermore, for example, at the portion below the second ribs 32b of the lighting device 1-22, the second ribs 32b are positioned above so that the width direction of the second ribs 32b is in the vertical direction. Thus, the air being warmed by the heat that is transmitted from the light source 10 to the base 20 moves through the second ribs 32b in the direction away from the base 20, that is, in the upward direction, without substantially being affected by the second ribs 32b. In other words, because the width direction of the second ribs 32b is positioned along the upward direction of the heat, the air being warmed by the heat effectively moves through the second ribs 32b in the direction away from the base 20, that is, in the upward direction. In this manner, in the lighting device 1-22, the heat radiation efficiency is further improved than those of the lighting devices 1-21 and 123 that correspond to the other irradiation directions.

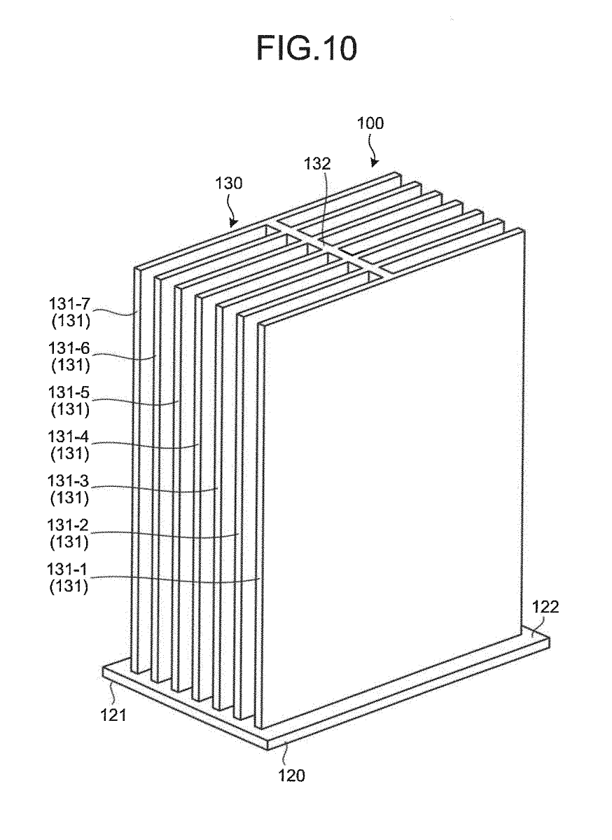

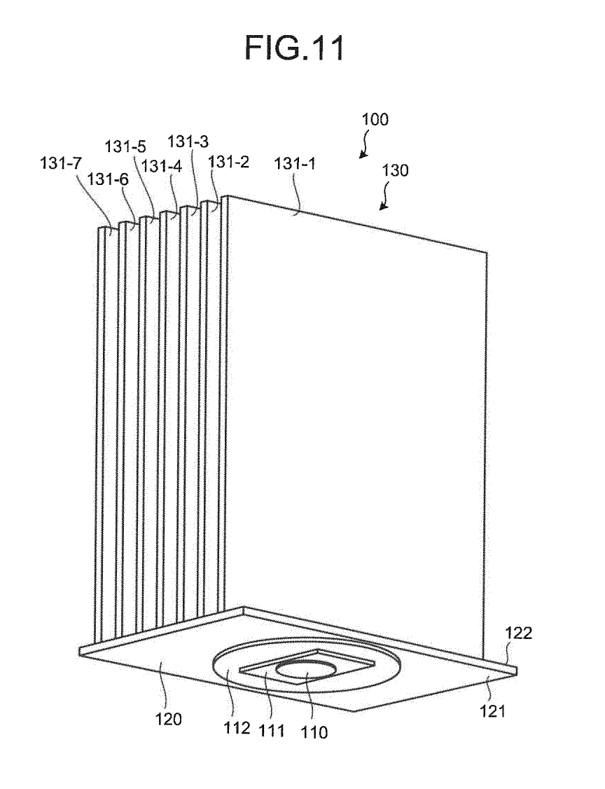

A structural example of a conventional heat radiation member will now be described using a lighting device 100 according to a conventional example illustrated in FIGS. 10 to 14. The lighting device 100 includes a light source 110, a base 120 in a plate shape, and a heat radiation member 130. The light source 110 is the LED, for example. Further, the light source 110 is provided on a substrate 111, and the substrate 111 is disposed on a mounting unit 112 that is provided on a surface 121 of the base 120.

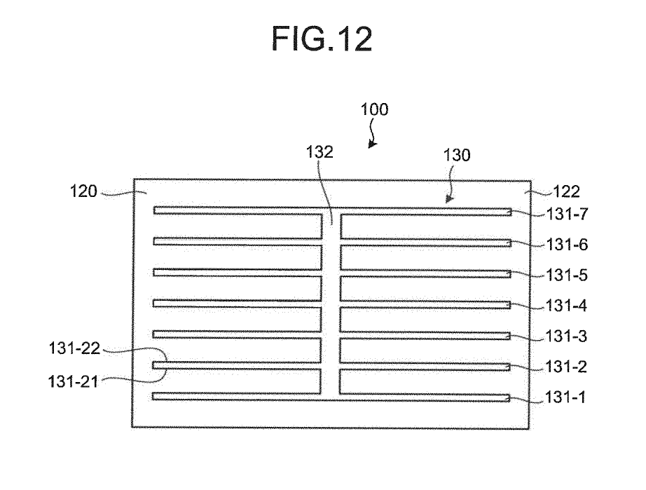

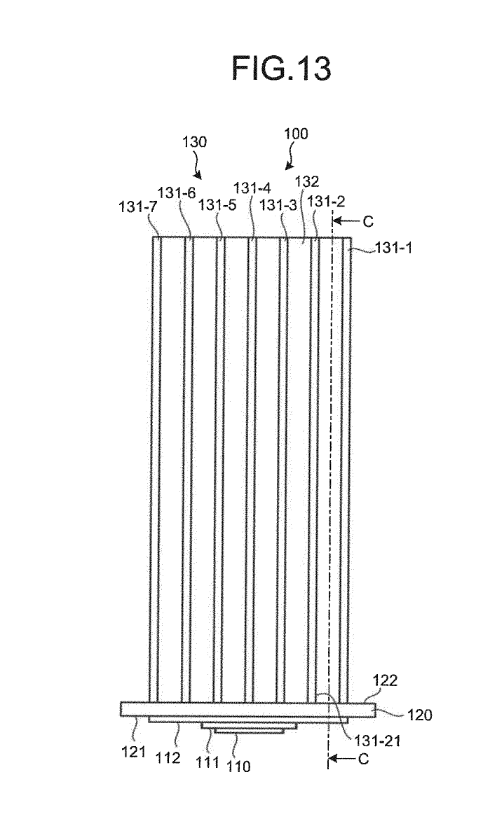

In the lighting device 100, the heat radiation member 130 includes a plurality (seven pieces) of heat radiation fins 131-1 to 131-7 that is arranged in a predetermined direction. If the heat radiation fins 131-1 to 131-7 need not be distinguished from one another, they are referred to as heat radiation fins 131. The heat radiation fins 131 are arranged in the thickness direction of the heat radiation fins 131. It is assumed that the lighting device 100 rotates around an axis in the thickness direction of the heat radiation fins 131. In the lighting device 100, the base 120 and the heat radiation member 130 are formed integrally, and the heat radiation fins 131 are disposed upright from an opposite surface 122 of the surface 121 of the base 120. Further, the heat radiation member 130 includes the center rib 132 for linking the heat radiation fins 131. As illustrated in FIG. 10 and FIG. 13, the center rib 132 is formed across the entire heat radiation fins 131 in the upright direction, so as to link the center portions of the heat radiation fins 131 in the width direction. Further, as illustrated in FIG. 10 and FIG. 12, the center rib 132 extends from the heat radiation fin 131-1 to the heat radiation fin 131-7 and connects the heat radiation fins.

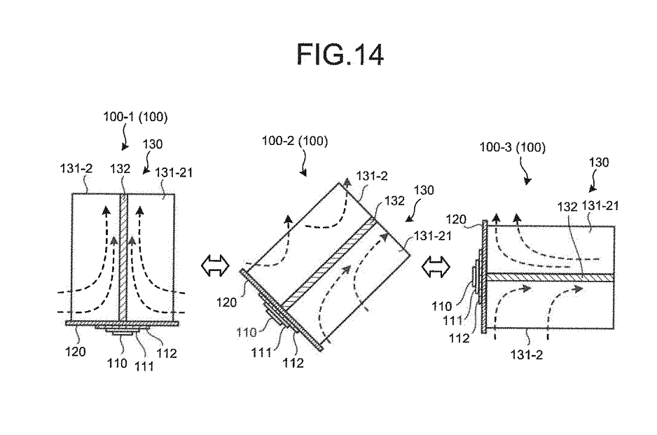

Next, a heat radiation state when the orientation of the lighting device 100 is changed will be described with reference to FIG. 14. FIG. 14 is a diagram illustrating relations between the orientation of the lighting device and the center rib according to the conventional example. Each of lighting devices 100-1 to 100-3 illustrated in FIG. 14 is the lighting device 100 in each irradiation direction. If the lighting devices 100-1 to 100-3 need not be distinguished from one another, they are referred to as the lighting devices 100. Each of the lighting devices 100 illustrated in FIG. 14 is a plan view of a section taken along the line C-C in FIG. 13. More specifically, each of the lighting devices 100 illustrated in FIG. 14 is a plan view of a facing surface 131-21 that faces the heat radiation fin 131-1, in the heat radiation fin 131-2.

For example, the irradiation direction of the lighting device 100-1 is downward (directly downward). In the following, the direction toward which the surface 121 of the base 120 in the lighting device 100-1 in FIG. 14 faces is the downward direction, and the direction toward which the opposite surface 122 of the base 120 in the lighting device 100-1 faces is the upward direction. The irradiation direction of the lighting device 100-2 is a direction inclined by 45 degrees (oblique direction) from the downward directions The irradiation direction of the lighting device 100-3 is the lateral direction (horizontal direction), more specifically, in the leftward direction. The lighting device 100 can rotatably change its direction among the positions of the lighting device 100-1 to the lighting device 100-3.

The dotted lines that overlap with the heat radiation member 130 of the lighting device 100 illustrated in FIG. 14 indicate the air flow in the heat radiation member 130. The dotted lines illustrated in FIG. 14 indicate the state of the flow of air that is warmed by the heat in the heat radiation member 130 in a virtual manner.

For example, in the lighting device 100-1, the air being warmed by the heat that is transmitted from the light source 110 to the base 120 moves upward in the direction away from the base 120, that is, in the upright direction of the heat radiation member 130. Further, for example, at the portion above the center rib 132 of the lighting device 100-2, the air being warmed by the heat that is transmitted from the light source 110 to the base 120 moves in the direction away from the base 120, that is, in the upward direction. Furthermore, for example, at the portion below the center rib 132 of the lighting device 100-2, the air being warmed by the heat that is transmitted from the light source 110 to the base 120 moves in the direction away from the base 120 along the center rib 132, that is, in the upward direction.

However, at the portion below the center rib 132 of the lighting device 100-3, the center rib 132 positioned above affects the air being warmed by the heat that is transmitted from the light source 110 to the base 120. Consequently, it is difficult to effectively radiate heat.

On the other hand, as described above, in the lighting device 1 according to the present embodiment, even though the heat radiation efficiency of the first ribs 32a is reduced at the state of the lighting device 1-12, the heat radiation efficiency of the second ribs 32b is further improved than those of other irradiation directions at the state (state of the lighting device 1-22). Consequently, because the heat radiation effect of the lighting device 1 as a whole becomes equivalent to those of other irradiation directions, it is possible to suppress the influence on heat radiation due to the change in orientation.

Further, the irradiation direction of the lighting device 1 can be changed in the rightward direction. However, when the irradiation direction is changed in the rightward direction, the air can easily pass through the first ribs 32a in the oblique direction, but the air cannot easily pass through the second ribs 32b in the oblique direction. In other words, when the irradiation direction is changed in the rightward direction, the state corresponds to the example described above when the irradiation direction is changed in the leftward direction, in which the first ribs 32a and the second ribs 32b are replaced.

Consequently, for example, when the lighting device 1 is in the oblique rightward direction, the heat radiation efficiency of the second ribs 32b is reduced, but the heat radiation efficiency of the first ribs 32a at the state is further improved than those of other irradiation directions. Because the heat radiation effect of the lighting device 1 as a whole becomes equivalent to those of other irradiation directions, it is possible to suppress the influence on heat radiation due to the change in orientation.

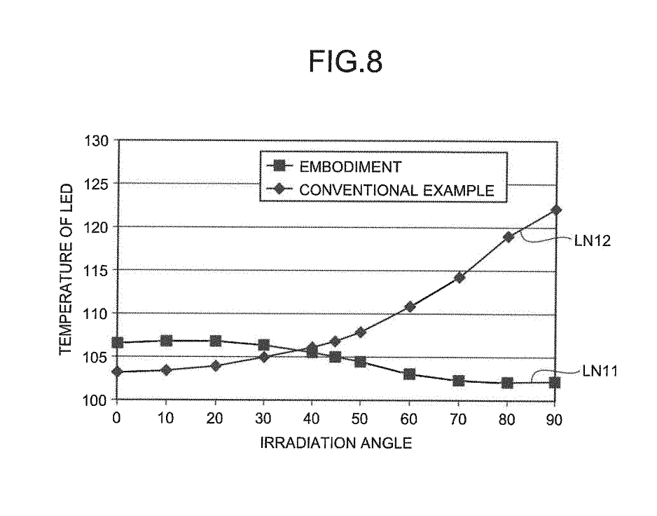

A comparison result between the heat radiation effect of the heat radiation member 30 of the present embodiment and the heat radiation effect of the heat radiation member 130 of the conventional example will now be described with reference to FIG. 8. FIG. 8 is a diagram illustrating a comparison between the embodiment and the conventional example. More specifically, FIG. 8 indicates the change in temperature of the LEDs that are used as the light sources 10 and 110, when each irradiation direction (irradiation angle) of the lighting device 1 according to the embodiment and the lighting device 100 according to the conventional example is changed between 0 degree and 90 degrees. For example, when the irradiation direction (irradiation angle) is 0 degree, the irradiation direction is downward (directly downward), and corresponds to the lighting device 1-11 in FIG. 6 and the lighting device 100-1 in FIG. 14. When the irradiation direction (irradiation angle) is 45 degrees, the irradiation direction is inclined by 45 degrees from the downward direction (oblique direction), and corresponds to the lighting device 1-12 in FIG. 6 and the lighting device 100-2 in FIG. 14. When the irradiation direction (irradiation angle) is 90 degrees, the irradiation direction is the lateral direction horizontal direction), more specifically, in the leftward direction, and corresponds to the lighting device 1-13 in FIG. 6 and the lighting device 100-3 in FIG. 14.

A line LN 11 illustrated in FIG. 8 indicates the temperature change in the LED that is the light source 10 of the lighting device 1. A line LN 12 illustrated in FIG. 8 indicates the temperature change in the LED that is the light source 110 of the lighting device 100. In the result illustrated in FIG. 8, the temperatures of the LEDs of the lighting device 1 and the lighting device 100 are both around 105 degrees Celsius, when the irradiation direction (irradiation angle) is from around 0 degree to 45 degrees. However, when the irradiation direction (irradiation angle) becomes equal to or more than 50 degrees, the temperature of the LED of the lighting device 100 starts to rise, but the temperature of the LED of the lighting device 1 starts to fall. When the irradiation direction (irradiation angle) becomes 90 degrees, the temperature of the LED of the lighting device 1 becomes around 102 degrees Celsius, but the temperature of the LED of the lighting device 100 becomes around 123 degrees Celsius. In this manner, as the irradiation direction (irradiation angle) is increased, the temperature of the LED of the lighting device 100 is increased, but the temperature of the LED of the lighting device 1 becomes substantially uniform. Consequently, compared to the conventional lighting device 100, the lighting device 1 can suppress the influence on heat radiation due to the change in the irradiation direction (irradiation angle).

In the lighting device 1 described above, in the plan view of the heat radiation fin 31, the ribs 32 (first ribs 32a) that extend to and connect to the first surface of one of the heat radiation fins 31 and the ribs 32 (second ribs 32b) that extend to and connect to the second surface that is the opposite surface to first surface of the heat radiation fin 31, are line-symmetrical with respect to an axis of a virtual line that passes through the center of the heat radiation fins 31 in the width direction and that extends in the upright direction. More specifically, in the plan view of the heat radiation fin 31, the ribs 32 (first ribs 32a-2) that extend to and connect to the first surface of the heat radiation fin 31-4 and the ribs 32 (second ribs 32b-2) that extend to and connect to the second surface that is the opposite surface to the first surface of the heat radiation fin 31-4, are line-symmetrical with respect to the axis of the virtual line that passes through the center of the heat radiation fins 31 in the width direction and that extends in the upright direction.

Furthermore, one of the ribs 32 and the another rib 32 are line-symmetrical with respect to the center line (not illustrated) that extends in the upright direction of the heat radiation fins 31 and that passes through the center of both ends of the heat radiation fins 31 in a predetermined direction (Z axis direction) as well as the center of the heat radiation fins 31 in the width direction. For example, in the lighting device 1, the center line passes through the center of the heat radiation fin 31-4 in the thickness direction as well as the center of the heat radiation fin 31-4 in the width direction, and extends in the upright direction of the heat radiation fins 31. For example, in the heat radiation member 30, the second rib 32b-14 and the first rib 32a-34 are line-symmetrical with respect to the center line that passes through the center of both ends of the heat radiation fine 31-1 and 31-7 in the thickness direction of the heat radiation fins 31, as well as the center of the heat radiation fins 31 in the width direction.

Furthermore, the ribs 32 that are provided on each of the facing surfaces include one of the ribs 32 and another of the ribs 32 the height of which in the upright direction of the heat radiation fins 31 is the same as that of the rib 32, as well as the distance from the sectional surface that is orthogonal to the heat radiation fins 31 in the width direction and that passes through center of the heat radiation fins 31 in the thickness direction is the same as that of the rib 32. For example, in the heat radiation member 30, the rib 32 include the first rib 32a-13 and the second rib 32b-33 the height of which in the upright direction of the heat radiation fins 31 is the same as that of the first rib 32a-13, as well as the distance from the sectional surface that is orthogonal to the heat radiation fins 31 in the width direction and that passes through the center of the heat radiation fins 31 in the thickness direction is the same as that of the first rib 32a-13.

Further, in the example illustrated above, the ribs 32 are arranged in a line in the upright direction of the heat radiation fins 31, between the facing heat radiation fins 31. However, the ribs 32 may be provided between the facing heat radiation fins 31 in any manner, as long as the influence on heat radiation due to the change in orientation can be suppressed. For example, the ribs 32 may be arranged in a plurality of lines in the upright direction of the heat radiation fins 31, between the facing heat radiation fins 31. For example, the ribs 32 may be arranged in two lines in the upright direction of the heat radiation fins 31 between the facing heat radiation fins 31.

For example, the heat radiation member may be used for a lighting device 2 as illustrated in FIG. 9. FIG. 9 is a perspective view illustrating another lighting device uses the heat radiation member according to the embodiment. For example, the lighting device 2 illustrated in FIG. 9 is a lighting device that is used as what is called a spotlight. As illustrated in FIG. 9, the lighting device 2 may include a predetermined light source unit 210 and the heat radiation member 30 in a casing 200. Further, in the example in FIG. 9, the lighting device 2 is rotatably fitted on a ceiling using the fitting mechanism 230 including the arm member 220. The lighting device 2 described above is an example, and the heat radiation member 30 may be used in various lighting devices such as a downlight (universal). Further, the heat radiation member 30 may be applied to any device as long as the heat radiation member 30 is applicable to the device.

According to an embodiment of the present invention, it is possible to suppress the influence on heat radiation due to the change in orientation.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A heat radiation member, comprising:
a plurality of heat radiation fins each formed in a plate shape, the plurality of heat radiation fins being disposed upright from a base on which a light source is to be fitted, and being arranged in a predetermined direction; and
a plurality of ribs that extends to each of facing surfaces of the plurality of heat radiation fins and that is provided on a part of the plurality of heat radiation fins in an upright direction.

2. The heat radiation member according to claim 1, wherein the plurality of ribs is inclined relative to the upright direction of the plurality of heat radiation fins.

3. The heat radiation member according to claim 1, wherein the plurality of ribs is spaced apart in the upright direction of the plurality of heat radiation fins and is provided on each of the facing surfaces.

4. The heat radiation member according to claim 3, wherein the plurality of ribs that is between a pair of the facing surfaces has inclination directions aligned relative to the upright direction of the plurality of heat radiation fins.

5. The heat radiation member according to claim 1, wherein the plurality of ribs that is provided on each of the facing surfaces includes a group of first ribs and a group of second ribs the group of first ribs being inclined in a first direction relative to the upright direction of the plurality of heat radiation fins and the group of second ribs being inclined in a second direction being opposite to the first direction, relative to the upright direction of the plurality of heat radiation fins.

6. The heat radiation member according to claim 5, wherein the group of first ribs and the group of second ribs are equal in number.

7. The heat radiation member according to claim 1, wherein one of the plurality of ribs and another of the plurality of ribs are line-symmetrical with respect to a center line, the center line extending in the upright direction of the plurality of heat radiation fins and passing through a center of both ends of the plurality of at radiation fins in the predetermined direction and a center of the plurality of heat radiation fins in a width direction.

8. The heat radiation member according to claim 1, wherein the plurality of heat radiation fins is odd in number.

9. A lighting device, comprising:
the heat radiation member according to claim I; and
a light source that is fitted to the heat radiation member.

10. The lighting device according to claim 9, wherein
the light source rotates around a predetermined rotation axis to change an irradiation direction.
